(19) United States
(12) Patent Application Publication
(10) Pub. No.: US 2003/0061726 A1
(43) Pub. Date: Apr. 3, 2003

(54) Method for drying coatings on substrates for lamps

(75) Inventors: Armin Konrad, Schwabmuenchen (DE); Martin Zachau, Geltendorf (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 10/253,705

(22) Filed: Sep. 25, 2002

(30) Foreign Application Priority Data
Sep. 28, 2001 (DE) 101 47 952.2

(51) Int. Cl. F26B 3/34; F26B 3/32

(52) U.S. Cl. 34/245; 34/266; 34/519

(57) ABSTRACT

The invention relates to a method for drying wet or moist coatings on substrates for lamps, in which at least 25%, advantageously more than 50%, of the electromagnetic energy from a thermal radiator which is supplied for drying the coatings lies in the wavelength range between 0.7 and 1.5 μm. Tubular radiators (5) are used as thermal radiators for generating the electromagnetic radiation.

### TECHNICAL FIELD

The invention is based on a method for drying wet or moist coatings on substrates for lamps, in which the energy required to dry the coatings is supplied in the form of electromagnetic radiation from a thermal radiator. The substrates may be tubular, straight discharge vessels for fluorescent lamps, tubular discharge vessels which are bent one or more times for compact low-pressure discharge lamps or plate-like discharge vessels for discharge lamps which are operated with dielectric barrier discharge. However, the method is also suitable for outer bulbs for compact low-pressure discharge lamps or bulbs for incandescent lamps.

### BACKGROUND ART

Currently, glass tubes for lamps which have been covered with organic or aqueous suspensions are dried either using blown air which has been heated to 20 to 150° C. or using infrared radiation in the wavelength region above 2 μm.

In the former case, the glass bulb is passed through a heat bath consisting of air and at the same time hot air is blown through the interior of the bulb. In the process, the surfaces come into contact with the heat bath, so that firstly the glass surface and the liquid surface are heated. The surfaces are initially at a higher temperature than the volume which is not in direct contact with the hot air. This temperature difference can be gradually evened out through thermal conduction through the glass and the liquid, provided that this process takes place quickly enough. On the other hand, coating defects occur.

On the one hand, blown air which is too strong or too hot leads to the formation of a skin at the liquid surface, and this then tears open as the drying process continues, leaving behind a cracked layer. Secondly, if the heat bath is at an excessively high temperature, the glass surface is heated too intensively, so that there is insufficient temperature leveling in the coating on account of insufficient thermal conduction, and consequently the coating begins to boil and has defects.

In the second case, the glass bulb is heated from the outside using IR radiation. In this case, the wavelength is selected to be such that the radiant energy is absorbed predominantly to completely in the glass. If the radiation intensity is increased excessively, coating defects, in the form of cracks and bubbles, occur, similarly to a heat bath which is at an excessively high temperature.

In each case, only a limited introduction of energy is possible, and a lower limit for the drying time of straight, tubular fluorescent lamp bulbs with a diameter of 26 mm and a length of 1500 mm is approx. 2 minutes. The times which can currently be achieved on an industrial scale are 8 to 10 minutes. The same applies to other geometries and types of lamps.

### DISCLOSURE OF THE INVENTION

It is an object of the present invention to provide an improved method for drying wet or moist coatings on substrates for lamps.

In the improved method for drying wet or moist coatings on substrates for lamps, in which the energy required to dry the coatings is supplied in the form of electromagnetic radiation from a thermal radiator, at least 25% of the electromagnetic radiation supplied by the thermal radiator lies in the wavelength range between 0.7 and 1.5 μm.

Near infrared radiation (NIR radiation) is described by black-body radiation with a surface temperature of 2000 to 3700 Kelvin, corresponding to an emission maximum at a wavelength of 1.5 to 0.78 μm. Compared to IR radiation, NIR radiation is generated by a higher surface temperature on the part of the radiation source. In the NIR radiation region, water has weak absorption bands at 0.9, 1.2 and 1.4 μm, but the glass, compared to the IR region (λ>2.0 μm) has no absorptivity or only a low absorptivity. Therefore, the NIR radiation is not absorbed or is only weakly absorbed by glass, and consequently most of it is transmitted. Consequently, it is possible for the water in a wet or moist coating on a glass to be heated directly without the intermediate step involving thermal conduction through the glass. Since, moreover, the absorption by water is relatively weak in the NIR region, in this case the coating is heated very homogeneously and uniformly. Formation of bubbles during the drying is avoided, and thermal conduction in the coating is surplus to requirements.

The fact that the radiation output increases by the 4th power of the surface temperature of the radiator, in accordance with the Stefan-Boltzmann law, means that at a higher surface temperature, a significantly higher radiation output is also available. The combination of direct heating of the coating which is to be dried and a higher radiation output means that the drying time can be significantly shortened. The proportion of the electromagnetic radiation for drying wet or moist coatings on substrates which lies in the NIR region should be at least 25%, advantageously more than 50%.

The coatings may consist of solutions and/or lacquers and/or suspensions comprising solids, such as for example phosphors. The substrates preferably consist of glass or plastic with similar radiation-optical properties to glass.

Since the method allows the radiation to be introduced into the coating/substrate assembly from the side of the discharge vessel, the drying method is considerably simplified.

The thermal radiators for generating the electromagnetic radiation which are used are preferably tubular radiators, the substrates being moved relative to the arrangement of tubular radiators during the drying method.

To achieve drying which is as uniform as possible, the tubular radiators should be arranged in a plane which is parallel to the plane covered by the axis of the substrates and the direction in which the substrates are conveyed.

Reflectors for the electromagnetic radiation, which divert electromagnetic radiation toward the substrates, are advantageously arranged on that side of the tubular radiators which is remote from the substrates. Moreover, the same type of reflectors should additionally be arranged on that side of the substrates which is remote from the tubular radiators, in order to divert electromagnetic radiation toward the substrates. In this way, it is possible to achieve energy savings of up to 50% compared to other methods, substantially by means of two properties. Firstly, the NIR radiation can be focussed by the reflectors onto the region which is to be heated, and secondly scattered light or unabsorbed radiation can be reused in a targeted manner. There is no excessive heating of the glass bulb, since the absorption of the NIR radiation is effected primarily by the water which is to be evaporated.

The tubular radiators are advantageously arranged with their axis at an angle of between 0° and 90° to the direction in which the substrates are conveyed. In addition, during the drying operation they can be moved perpendicular to the direction in which the substrates are conveyed, in the plane covered by the radiators. In this way, the number of radiators required for the drying operation can be reduced.

The invention also relates to a method for producing a tubular fluorescent lamp having a coating, and to a fluorescent lamp having a coating on the inner side of the tubular discharge vessel, in which the phosphor coating is dried using the method described above.

### BRIEF DESCRIPTION OF THE DRAWINGS

In the text which follows, the invention is to be explained in more detail with reference to an exemplary embodiment. In the drawing:

FIG. 1 shows a diagrammatic side view of the drying method for linear fluorescent lamps with the aid of tubular NIR radiators.

FIG. 2 shows a diagrammatic plan view of the method shown in FIG. 1 on an enlarged scale with additional reflectors.

### BEST MODE FOR CARRYING OUT THE INVENTION

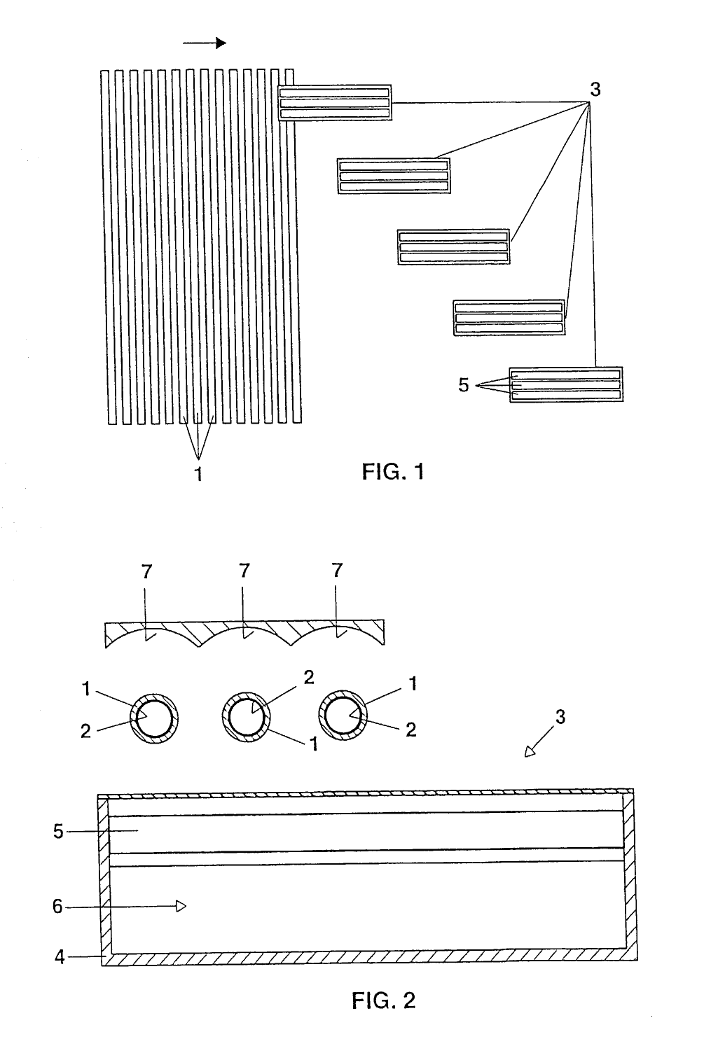

FIGS. 1 and 2 show a drying method according to the invention for drying a phosphor coating 2 on tubular discharge bulbs 1 for fluorescent lamps. The phosphor coating 2 is in this case applied to the inner side of the tubular discharge bulb 1, which is made from glass, and consists of an aqueous suspension comprising solids. The discharge bulbs 1 are arranged vertically and during the drying operation are guided past the horizontally arranged NIR radiation devices 3 in the direction indicated by the arrow.

The NIR radiation devices 3 comprise a housing 4 with cover plate, into which in each case three tubular NIR radiators 5 with reflectors 6 for focussing the NIR radiation onto the discharge bulbs 1 are installed. To successively dry the coating along the axis of the discharge bulbs, the drying installation has five NIR radiation devices 3, which are arranged offset along the direction of transport of the discharge bulbs 1.

As shown in FIG. 2, additional reflectors 6 for focussing scattered light and unabsorbed radiation onto the phosphor coating 2 are provided on the opposite side of the discharge bulbs 1 (in FIG. 1, these reflectors were omitted for reasons of clarity).

With the drying method illustrated here, it is possible to shorten the drying time for a phosphor coating on fluorescent lamp bulbs with a diameter of 26 mm and a length of 1500 mm to approx. 10 seconds. Consequently, it is possible to use considerably smaller drying installations. By using near infrared radiation, it is possible to shorten the drying time by a multiple of five to ten compared to conventional IR radiation. At the same time, the energy consumption falls by approximately half.

What is claimed is:

1. A method for drying wet or moist coatings on substrates for lamps, in which the energy required to dry the coatings is supplied in the form of electromagnetic radiation from a thermal radiator, and at least 25% of the electromagnetic radiation supplied by the thermal radiator lies in the wavelength range between 0.7 and 1.5 μm.

2. The method as claimed in claim 1, in that more than 50% of the electromagnetic radiation supplied lies in the wavelength range between 0.7 and 1.5 μm.

3. The method as claimed in claim 1, in that the coatings consist of solutions and/or lacquers and/or suspensions comprising solids.

4. The method as claimed in claims 1 and 3, in that the solids which are present in the suspensions are phosphors.

5. The method as claimed in claim 1, in that the substrates consist of glass.

6. The method as claimed in claim 1, in that the substrates are made from plastics.

7. The method as claimed in claim 1, in that the radiation is introduced into the coating/substrate assembly from the substrate side.

8. The method as claimed in claim 1, in that the substrates comprise tubular bulbs.

9. The method as claimed in claim 8, in that the tubular bulbs run in a straight line.

10. The method as claimed in claim 8, in that the tubular bulbs are bent one or more times.

11. The method as claimed in claim 1, in that the thermal radiators for generating the electromagnetic radiation are tubular radiators.

12. The method as claimed in claim 11, in that during the drying method the substrates are moved relative to the arrangement of tubular radiators.

13. The method as claimed in claim 11, in that the tubular radiators are arranged in a plane which is parallel to the plane covered by the axis of the substrates and the direction in which the substrates are conveyed.

14. The method as claimed in claim 11, in that reflectors for the electromagnetic radiation, which divert electromagnetic radiation toward the substrates, are arranged on that side of the tubular radiators which is remote from the substrates.

15. The method as claimed in claim 11, in that reflectors for the electromagnetic radiation, which divert electromagnetic radiation toward the substrates, are arranged on that side of the substrates which is remote from the tubular radiators.

16. The method as claimed in claim 11, in that the tubular radiators are arranged with their axis at an angle of between 0° and 90° to the direction in which the substrates are conveyed.

17. The method as claimed in claim 11, in that during the drying operation the tubular radiators are moved perpendicular to the direction in which the substrates are conveyed, in the plane covered by the radiators.

18. The method as claimed in claim 8, in that the tubular bulbs are tubes for fluorescent lamps.
